(19) United States
(12) Patent Application Publication
(10) Pub. No.: US 2015/0347990 A1
(43) Pub. Date: Dec. 3, 2015

(54) SYSTEM AND METHOD FOR MAKING LOW-COST INSTANTANEOUS FUNDS TRANSFERS

(71) Applicant: Archibald Leach Cobbs, Mountain Brook, AL (US)

(72) Inventor: Archibald Leach Cobbs, Mountain Brook, AL (US)

(21) Appl. No.: 14/288,360

(22) Filed: May 27, 2014

(51) Int. Cl. G06Q 20/10

(52) U.S. Cl. CPC G06Q 20/10

(57) ABSTRACT

A method and system is disclosed for providing a capability to transfer money directly between two U.S. bank accounts or other financial institution that is substantially instantaneous, that is relatively low-cost, that requires no prior account setup specific to each pair of accounts involved, that substantially reduces the risk of transaction denial due to insufficient funds, and that substantially reduces the risk of charge-backs after the transaction has been completed. The funds transfers enabled by the method and system can be cleared substantially instantaneously because no money actually enters or leaves either a sender's bank or a recipient's bank, involving only transfers of funds between accounts within the sender's bank, and between accounts within the recipient's bank. Account rebalancing among accounts needed to enable the method and system is performed as needed so as to substantially minimize interest costs incurred.

### FIELD OF THE INVENTION

The present invention relates to funds transfer systems, and more particularly to systems for the transfer of funds between two bank accounts.

### BACKGROUND OF THE INVENTION

Typically, the only ways to transfer money directly between two U.S. bank accounts are writing a check, electronic funds transfer (ACH), or wiring money. These methods, however, each have one or more of the following drawbacks: not being instantaneous, i.e., requiring several days for clearing; non-trivial transaction cost; requiring prior setup specific for each pair of accounts involved (making ad hoc funds transfers impossible); the risk of transaction denial due to insufficient funds; and/or charge-backs after the transaction has completed. Some funds transfer systems without these drawbacks exist, but they all require both parties in the funds transfer to have an account with an intermediary, for example PAYPAL™ and DWOLLA™.

The reason low-cost, instantaneous funds transfers don't exist is because ultimately every interbank transaction requires a settling transfer between those two banks' Federal Reserve accounts, thereby making the process too inefficient for frequent transfers and small amounts. In other words, no suitable clearing entity exists.

With regards to speed of clearing, in general there is a trade-off between time and money. For example, wire transfers are fast but expensive, providing same-day money transfer, but costing typically $25 per transaction. Another example is PopMoney™, which charges $0.95 per transaction, and takes a minimum of one business day to clear. The bank-backed ClearXchange™, which uses the ACH network, is free for customers of participating banks, takes up to 3 business days to clear, and has transfer limits of $1,000 per day, $2,500 per week, and $10,000 per month.

Another example of funds transfer is described in US Patent Application Publication 2012/0173409 A1, which describes a funds transfer network that allows global real-time funds transfers among banks. This funds transfer approach requires an intermediate bank.

The Federal Reserve has recently released a white paper (See http://fedpaymentsimprovement.org/wp-content/uploads/2013/09/Payment_System_Improvement-Public_Consultation_Paper.pdf) asking for public input on ways to improve electronic funds transfers, which suggests that current funds transfer systems are inadequate.

### SUMMARY OF THE INVENTION

The invention provides a capability to transfer money directly between two U.S. bank accounts that is substantially instantaneous (taking substantially less time than a wire transfer, e.g. seconds rather than hours), relatively low-cost (costing substantially less than a wire transfer, for example), that requires no prior account setup specific to each pair of accounts involved (making ad hoc funds transfers possible), that substantially reduces the risk of transaction denial due to insufficient funds, and that substantially reduces the risk of charge-backs after the transaction has completed.

A first general aspect of the invention is a method for making low-cost instantaneous funds transfers from a bank account of a sender directly to a bank account of a recipient. The method includes: after receiving instructions to transfer funds from a bank account of the sender in a first bank to a bank account of the recipient in a second bank, transmitting instructions to the first bank to transfer funds from the bank account of the sender in the first bank to a first funds transfer system account in the first bank; transmitting instructions to the second bank to transfer funds from a second funds transfer system account in the second bank to the bank account of the recipient in the second bank; transferring funds from the bank account of the sender in the first bank to a first funds transfer system account in the first bank; and transferring funds from the second funds transfer system account in the second bank to the bank account of the recipient in the second bank.

In some embodiments, transmitting instructions to the first bank to transfer funds from the bank account of the sender in the first bank to a first funds transfer system account in the first bank is made to occur substantially simultaneously with transmitting instructions to the second bank to transfer funds from a second funds transfer system account in the second bank to the bank account of the recipient in the second bank.

In some embodiments, transferring funds from the bank account of the sender in the first bank to a first funds transfer system account in the first bank is made to occur substantially simultaneously with transferring funds from the second funds transfer system account in the second bank to the bank account of the recipient in the second bank.

In some embodiments, either: both transferring funds from the bank account of the sender in the first bank to a first funds transfer system account in the first bank is made to occur, and transferring funds from the second funds transfer system account in the second bank to the bank account of the recipient in the second bank is made to occur, OR neither transferring funds from the bank account of the sender in the first bank to a first funds transfer system account in the first bank is made to occur, nor is transferring funds from the second funds transfer system account in the second bank to the bank account of the recipient in the second bank made to occur.

In some embodiments, the method further includes: before receiving instructions from a sender of funds to transfer funds from a bank account of the sender in a first bank to a bank account of the recipient in a second bank, both sender and recipient irrevocably agree that the transaction is allowed; and the transaction is confirmed to both sender and recipient.

In some embodiments, the method further includes: before transferring funds from the second funds transfer system account in the second bank to the bank account of the recipient in the second bank, determining whether the second funds transfer system account has enough money to remain positive after transferring funds; and if the second funds transfer system account does not have enough money to remain positive after transferring funds, borrowing funds from a funding source to at least cover the transferring of funds from the second funds transfer system account in the second bank to the bank account of the recipient in the second bank.

Another general aspect of the invention is a system for making low-cost instantaneous funds transfers from a bank account of a sender in a first bank directly to a bank account of a recipient in a second bank. The system includes: a first funds transfer system (FTS) account in a first bank capable of participating in internal funds transfers with other accounts in the first bank; a second funds transfer system (FTS) account in a second bank capable of participating in internal funds transfers with other accounts in the second bank; an FTS software agent capable of communicating funds transfer instructions; and a funds transfer system (FTS) coordinator having: a rebalancing coordinator capable of determining amounts and times of funds transfers among a plurality of FTS accounts so as to minimize negative balances in the plurality of FTS accounts; an interbank funds transfer network interface for communicating with an interbank funds transfer network capable of transferring funds among the plurality of FTS accounts in accordance with instructions from the rebalancing coordinator; a front-end for receiving funds transfer instructions via an API from the FTS software agent; and a back-end for: sending funds transfer instructions via an API to an API of the first bank so as to cause a first transfer of funds from a bank account of the sender in the first bank to the first FTS account in the first bank, sending funds transfer instructions via an API to an API of the second bank so as to cause a second transfer of funds from the second FTS account in the second bank to a bank account of the recipient in the second bank, sending from the first bank to the FTS coordinator confirmation of the first transfer of funds, and sending from the second bank to the FTS coordinator confirmation of the second transfer of funds.

In some embodiments, the FTS software agent capable of communicating funds transfer instructions to the FTS coordinator includes an interface to at least one of: any gambling service, any e-commerce website, any brokerage website, any electronic service enabling transfer of money.

In some embodiments, the funds transfer instructions sent via an API from the FTS software agent to the FTS coordinator include metadata relating to the funds transfer.

In some embodiments, the FTS software agent is capable of receiving from the FTS Coordinator at least one of: confirmation of the funds transfer; and current balance information of the bank account of the sender.

In some embodiments, the system further includes: a recipient FTS software agent, wherein the recipient FTS software agent is capable of receiving from the FTS Coordinator at least one of: confirmation of the funds transfer; and current balance information of the bank account of the recipient.

### BRIEF DESCRIPTION OF THE DRAWINGS

The invention will be more fully understood by reference to the Detailed Description, in conjunction with the following figures, wherein:

FIG. 1 is a schematic diagram of an example embodiment of a funds transfer system (FTS) of the invention.

FIG. 2 is a block diagram illustrating how an FTS user interacts with a bank via the FTS system.

FIG. 3 is a flowchart of an example FTS user setup process.

FIG. 4 is a flowchart of an example of a request for funds transfer.

FIG. 5 is a flowchart of a funds transfer wherein a payee initiates an automatic funds transfer by sending a funds transfer token to a dedicated payer email address.

FIG. 6 is a graph of the transfer fee required to ensure interest costs are covered, as a function of the current interest rate, showing a plot for each of four different choices of the rebalancing interval.

### DETAILED DESCRIPTION

Reference will now be made to exemplary embodiments of the invention, which are illustrated in the accompanying drawings. This invention, however, can be embodied in various forms, and should not be construed as being limited to the embodiments set forth herein. Rather, these representative embodiments are described in detail so that this disclosure is thorough and complete, and fully conveys the scope, structure, operation, functionality, and potential of applicability of the invention to those skilled in the art. Wherever possible, the same reference numbers are used throughout the drawings to refer to the same or like parts.

Exemplary methods can be conceived to be a sequence of steps or actions leading to a desired result and can be implemented as software. While it may prove convenient to discuss such software as if it were embodied by a single program, most implementations will distribute the described functions among discrete (and some not so discrete) pieces of software. These pieces are often described using such terms of art as “programs.” Such programs are typically executed by a “processor”.

What is described herein is system for low-cost funds transfer between two bank accounts or financial institution accounts that can be cleared substantially instantaneously because no money actually needs to enter or leave either a sender's bank or a recipient's bank. The funds transfer system(s) described herein will be referred to hereinafter as “FTS”.

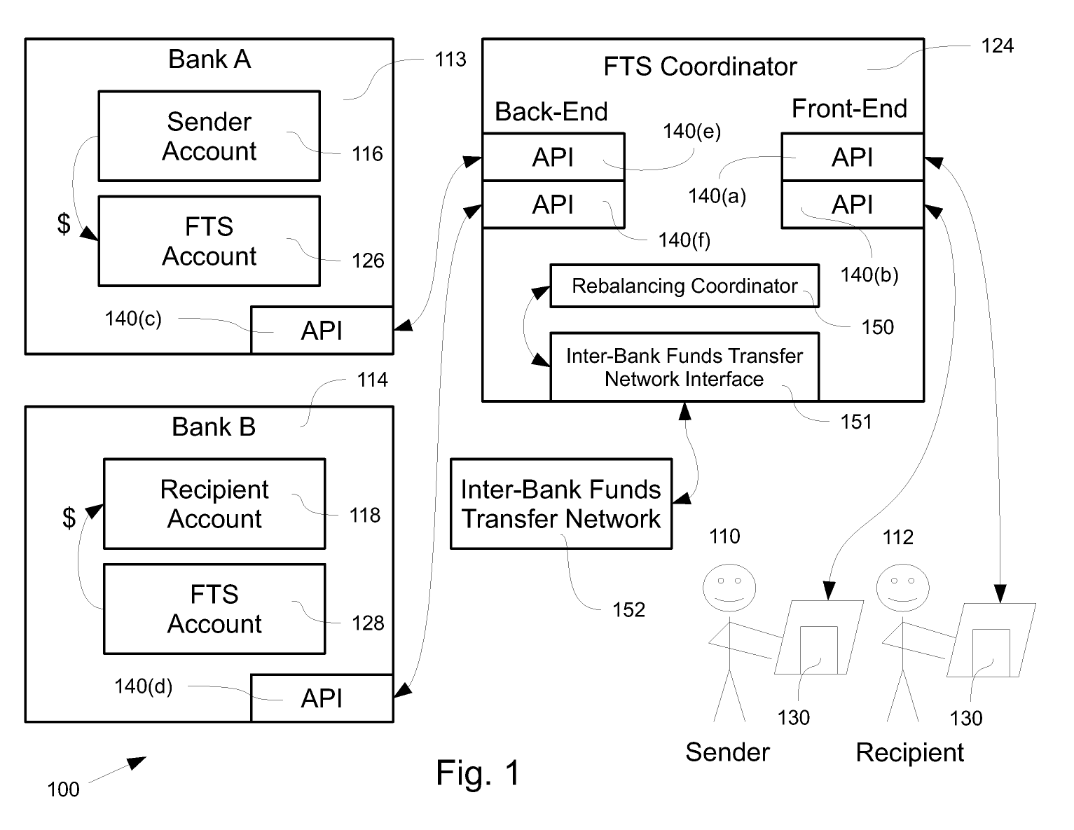

Referring to FIG. 1, wherein an example embodiment funds transfer system 100 includes a sender 110 transferring funds to a recipient 112. To achieve this, the FTS Coordinator 124 establishes a business relationship with participating sender Bank A (113) and recipient Bank B (114) in which exist, respectively, account 116, belonging to sender 110, and account 118, belonging to recipient 112. The FTS Coordinator 124 also has an account 126, 128 in each bank. During a transfer, the FTS Coordinator 124 instructs the sender Bank A to transfer money from the sender account 116 into the FTS account 126, and substantially simultaneously instructs the recipient Bank B to transfer money from FTS account 128 into the recipient account 118. The transfers are not necessarily truly simultaneous; however, they must be performed in such a way that either both occur or neither occurs.

Because each of these transfers occurs within a respective single bank, they can be cleared substantially immediately by the banks themselves. In an example embodiment, the system may be designed so that the overall transaction is “all or none”, so that either both transfers occur, or neither one does. In an example embodiment, a two-phase commit protocol, a standard technique for ensuring the integrity of distributed transactions well known to those skilled in the art, is used to ensure this “all or none” property. In a two-phase commit protocol, in a first step, both parties must agree that the transaction is allowed; once they have given this agreement, the parties may not revoke it. Then in a second step, the transaction is confirmed to both parties and the transfers actually occur. If either party does not agree in the first step, the transfer is instead canceled in the second step.

It can be seen that for intra-bank transfers, i.e., when by coincidence it so happens that Bank A and Bank B are actually the same bank, the FTS account's balance has a net zero change, but that for inter-bank transfers, the FTS account balance will go up in the sender's bank and will go down in the recipient's bank by the amount of the transfer. This represents an “imbalance”, and also implies that the FTS accounts require input from a separate source of money, at least enough to cover the imbalance. In other words, an imbalance can only be tolerated to the extent that it does not exceed the amount of money separately put into the FTS account, either at the time the imbalance occurs, or ahead of time. So there is a cost associated with having an imbalance, which is the cost of the interest on those funds used to compensate for the imbalance. Larger imbalances may be tolerated by putting more compensating money into the FTS accounts at partner banks, but at higher interest cost.

Over time the net imbalance will move up and down with each day's transfer activity. How exactly the net imbalance in any partner bank behaves over time depends on the statistical profile of all the FTS transfers involving that bank, such as their frequency, their size (amount in dollars), and their direction (deposit or withdrawal). If a large enough negative imbalance develops in any partner bank, it may be corrected with one or more wire transfers (or other forms of transfer) with other partnering bank(s) that have corresponding positive imbalances. This transfer effects a “rebalancing”. By this repeated action over time, the FTS effectively aggregates a large number of small transactions into a small number of larger rebalancing transfers, using its own accounts as what can be considered “buffers”.

In an example embodiment, the FTS account in each bank is pre-loaded with enough money to “buffer” inter-bank transfer flows, and handle any imbalance that accrues due to some number of transactions that occur over some period of time. However, there will always be some amount of money that is too large for the FTS to transfer because it exceeds the amount of “buffer” money in the FTS account. In such cases the FTS must reject the transfer, or resort to traditional means; if the latter, the unique combination of features provided by the FTS such as immediate clearing and low cost may of course no longer apply to that transfer. In this example, the FTS must pay interest on all of the “buffer” money, independently of whether there are imbalances or not.

In an example embodiment, rather than pre-loading the FTS accounts with “buffer” money, the FTS bank accounts all start out empty and by effect of a pre-existing agreement of a bank having an FTS account therein, the FTS account temporarily borrows from a credit line extended by such a bank to the FTS account as needed when the FTS account would otherwise have gone negative, thereby ensuring that the FTS account never goes negative. This is analogous to “overdraft protection” in retail banking. If the imbalance increases, more money is borrowed; if it decreases, money is automatically paid back. In other words, the FTS makes use of a credit line provided by each partner bank, whose balance due tracks the FTS account imbalance (or some portion thereof) over time. This embodiment has the advantage that interest is only paid for negative balances; and in particular, if a complete rebalancing were to occur, subsequent interest charges would drop to zero. Moreover, the maximum size of a transfer is now limited only by the partner bank credit limit. In an example embodiment, the FTS benefits from favorable interest rates and high credit limits based on a legal agreement with the partner bank to use the corresponding positive imbalances as loan collateral, in the form of actual cash.

When rebalancing does need to occur, it would proceed as follows. Referring to FIG. 1, within the FTS Coordinator 124, the Rebalancing Coordinator 150 monitors the balances of the various FTS accounts 126, 128 in the partner banks, and decides when to initiate rebalancing transfers. At the appropriate time, Rebalancing Coordinator 150 instructs Inter-Bank Funds Transfer Network Interface 151 to initiate one or more funds transfer(s) between FTS accounts in partner banks so that they become more evenly balanced. Inter-Bank Funds Transfer Network Interface 151 would perform this action by communicating with an existing Inter-Bank Funds Transfer Network 152. Examples of existing Inter-Bank Funds Transfer Networks 152 include the U.S. Federal Reserve wire transfer network and the Automated Clearing House (ACH) network. Other less automated examples include the writing and depositing of bank checks, and the physical transfer of cash via courier.

In an example embodiment, a wire transfer may be utilized to correct the imbalance. When a wire transfer does occur, the aforementioned credit line interest cost is lowered or reset to zero, and so interest costs stop accruing, but a wire transfer charge is instead incurred. Therefore, there is a trade-off between accrued interest costs versus transfer costs: allowing larger imbalances to accrue before rebalancing, and therefore rebalancing less often, means accrued interest costs will be higher, because more money must be borrowed, but transfer costs will be lower, because transfers occur less frequently. Conversely, rebalancing more frequently will result in lower accrued interest costs but higher transfer costs. Therefore, a strategy has been developed that substantially minimizes the overall combined cost of accrued interest and accrued transfer fees.

To develop such a strategy, a model of how the partner bank imbalances change over time has been constructed, as described below. Because money transfers are in part random, such a model necessarily incorporates probabilistic assumptions. For example, a model may assume that transfers involving any partner bank follow a normal (i.e., Gaussian) distribution having an average value at or near zero, where negative values represent withdrawals and positive values represent deposits. With such an assumption, the imbalance at that partner bank will, on average, grow with each transfer by an amount equal to the distribution's average. With an additional assumption that the number of transfers occurring each day does not change, then this would imply that the imbalance at that partner bank grows, on average, by a fixed amount each day. In any case, no matter what probabilistic model is assumed, it can be seen that as usage of the FTS increases, the factors that dictate its cost, such as frequency, size, and direction of transfers, will tend to moderate toward a statistical mean. Therefore, the system described herein benefits from the property that, all other things being equal, as usage increases, the accuracy of any such model should improve.

In one embodiment, a simple cost model is used which assumes that, on average, the imbalance at any partner bank will grow by a fixed amount each day. With this assumption, we can calculate the optimal interval, measured in days, at which to rebalance, such that overall cost (interest cost plus transfer cost) is minimized.

Let the number of days between rebalancing transfers be n. We will find the value of n that minimizes overall cost. Let d be the additional interest paid out each day (in dollars) due to the imbalance I (in dollars) having grown (by our model's assumption, this amount d will be constant). Let c be the number of days it takes for a rebalancing transfer to clear. Let w be the cost (in dollars) of performing the rebalancing transfer. Then first we observe that the average per-day cost due to transfers is w/n (dollars per day).

Next we examine the cost of transfer clearing time. Note that the amount of money transferred with each rebalancing nI must have a daily interest cost of nd, because it is the amount necessary to reverse n days of accumulated imbalance I. Note also that the effect of the clearing delay time c is that interest must be paid on the money nI being transferred for the c days that it takes to transfer. Therefore clearing time costs will equal ndc per transfer cycle, which means an average per-day cost of dc. Interestingly, this value is independent of n.

Next we examine the interest cost per cycle, which will be d+2d+3d+ . . . +nd which is equal to (d/2)(n²+n). On average then, the daily interest cost is this value divided by n, or (d/2)(n+1). So the overall cost is minimized when n is chosen so as to minimize the sum of (a) the average daily transfer cost, (b) the average daily clearing time cost, and (c) the average daily interest cost. This sum is w/n+dc+(d/2)(n+1). Applying basic calculus, we see this function is minimized when its partial derivative with respect to n, which is −w/n²+d/2, equals zero. Equating the partial derivative to zero and solving for n yields the formula n=√(2w/d).

For example, suppose the interest rate is 3.65%, immediately clearing wire transfers that cost $20 each are used to correct imbalances, and the imbalance grows at a rate of $10,000 per day. At 3.65% the daily interest on $10,000 is $1, and so d=1, w=20, and c=0. Therefore the optimal value for n is 6.32 days, or in other words, a rebalancing transfer of $63,200 should occur every 6.32 days to minimize overall cost. With this strategy the expected average overall daily cost is w/n+dc+(d/2)(n+1)=$6.82.

In another example, ACH transfers are used instead of wire transfers. Suppose the ACH transfers cost only $2.50 but take 3 days to clear. In that case d=1, w=2.5, and c=3. The optimal value for n is 2.24 days, but the average overall daily cost is $5.74. So in this example, when compared to wire transfers, ACH transfers would be nearly three times as frequent but still less expensive overall.

With any probabilistic model, the predicted costs will be approximate because the actual transfer pattern may differ from the assumptions of the model. For example, actual transfer amounts may not fit a normal distribution. For this reason, in some embodiments it may be prudent to allow for some margin for error in the predicted costs. For example, the FTS might set the transfer fee so as to ensure that the total revenue from all transfer fees was sufficient to pay for transfer costs even in the case actual transfer costs turned out to be 200% of that predicted by the model. Using the previous example's predicted daily cost of $5.74, and assuming 1,000 transfers per day, a transfer fee of $0.00574 per transfer would exactly cover the predicted costs, so a transfer fee at least twice that, or $0.01148 per transfer, would cover 200% of the predicted costs.

Looking at cost more generally, a key observation is that costs are directly related to how large and how quickly imbalances grow, and that, on average, larger transfers contribute more to the cost of the service than do smaller ones. There are two reasons for this: first, there is the direct effect that larger transfers (if in the “wrong” direction) can create proportionally larger imbalances than smaller transfers. Secondly, if one assumes a normal distribution for transfer amounts, then larger transfers are less common and therefore a longer time will elapse (on average) before a compensating large transfer in the reverse direction may occur, and during that time an imbalance exists and interest must be paid on it. Therefore, even when an unlimited credit line is available from partner banks, it may be prudent for the FTS to impose an upper limit on the amount of any single transfer, and/or the total amount of money transferrable by a single individual per day. The purpose of such a limit would be to avoid statistical “outlier” transfers that would have an inordinate effect on operational costs. To take an extreme example, a $10,000,000 transfer would result in a big jump in interest costs and/or trigger an immediate rebalancing and therefore incur a transfer cost. If the FTS were providing all transfers for a low, flat rate price, such large transfers would likely be negatively profitable, i.e., result in a loss. By imposing an upper limit on the transfer amount, the FTS could avoid these negatively profitable transfers, effectively ensuring that the actual transfer statistics did not exceed the assumed normal distribution curve in the two regions far away from the average, thereby ensuring that actual costs could not wildly exceed the costs predicted by the model.

In another embodiment, the FTS could vary its pricing according to the size of the transfer, with larger transfers costing more and smaller transfers costing less.

This would more closely align the price of a transfer with its contribution (on average) to the cost of running the service. In one embodiment of this idea, the FTS would set the price of any large transfer to be at least the cost of the daily interest on the transferred amount times the maximum number of days between normal rebalancing transfers. This would ensure that the additional interest cost attributable to the transfer was paid for by the fee charged for that transfer, and thereby ensuring that negatively profitable transfers simply could not occur. For example, suppose the FTS plans to rebalance every 5 days and the interest rate is 3.65%. Then the daily interest cost for each $1 of imbalance is $0.0001, and so any transfer of m dollars can increase interest costs by at most m times $0.0001 per day times 5 days, or $0.0005. Therefore, setting transfer pricing to be at least 0.05% of the amount transferred would ensure that the total revenue from transfer fees is always greater than or equal to total interest costs. This is a conservative approach, because transfers occur all throughout the 5 day period, not just at the beginning, and approximately half of all transfers should reduce, rather than increase, any imbalance. However, it does guarantee that interest costs will never exceed fees. In practice, the average time an imbalance exists will be approximately 2.5 days, and only approximately half of all transfers will result in an increased imbalance, so a fee of 0.05%/4=0.0125% would still be likely to result in transfer fees meeting or exceeding interest costs. Moreover, with this approach the other cost factor—rebalancing wire/ACH transfers—is completely predictable, occurring regularly every 5 days.

We can create a simple formula for this strategy as follows: let n be the rebalancing interval measured in days, and let i be the annual interest rate. Then the transfer fee f that is likely to ensure interest costs are below transfer fees is f=(0.5)(n/2)(i/365).

In another embodiment, there could be a threshold transfer amount (for example, $100) below which transfers were provided at no cost. Because the smallest transfers contribute, on average, very little to the cost of the service, this could be an effective and low cost marketing strategy to increase rapid adoption of the FTS service.

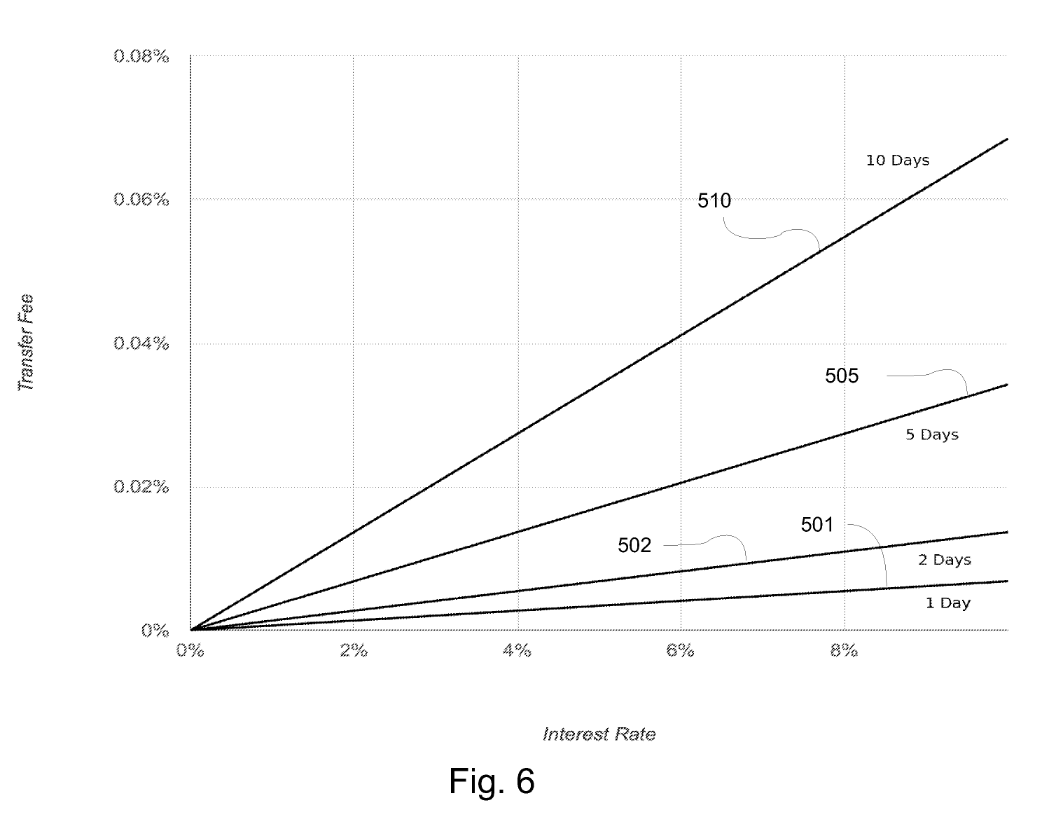

Referring to FIG. 6 the above transfer fee function f=(0.5)(n/2)(i/365) is plotted as a function of the interest rate i for a few different values of n (1, 2, 5, and 10). Plot line 501 shows the fee function for a one-day rebalancing interval. Plot line 502 shows the fee function for a two-day rebalancing interval. Plot line 505 shows the fee function for a five-day rebalancing interval. Plot line 510 shows the fee function for a ten-day rebalancing interval. Clearly, waiting longer to rebalance means proportionally higher interest costs. Taking an example scenario, it is clear from the graph that if the interest rate were 6% and rebalancing occurred every two days, a transfer fee of 0.01% would likely suffice to ensure interest costs are below transfer fee revenue. For a $100 transfer, this would amount to a fee of one cent. For a $1,000 transfer, this would amount to a fee of ten cents.

While much transfer activity may be essentially random, there are also likely to be some less random transfers that may be reliably predicted. For example, an employer who uses the FTS to pay its employees on a regular weekly basis will generate very predictable transfer patterns. When imbalances can be predicted ahead of time, then the FTS Rebalancing Coordinator 150 may choose to keep less “buffer” money in those partner bank accounts 126, 128 that are predicted to have net positive imbalances, and more “buffer” money in those partner bank FTS accounts predicted to have net negative imbalances. This can result in a lower number of total transfers and therefore a lower cost.

In one example embodiment, rebalancing transfers occur all at once every 7 days so that on average each partner bank FTS account starts each week with a balance of $100,000. A simple predictive model could be applied as follows: on transfer day, predictions are made for each partner bank of its net imbalance over the next 7 days by simply averaging the four actual net imbalances for that bank as measured during the four previous 7 day periods. Then, for example, if a partner bank FTS account is predicted to have a negative net imbalance of $25,000 at the end of the next 7 days, it would be rebalanced to $125,000 instead of $100,000.

Similarly, if a partner bank FTS account is predicted to have a positive net imbalance of $15,000, then it would be rebalanced to $85,0000 instead of $100,000. As a result, if the predictions were accurate, then at the end of the next 7 day period some partner bank FTS accounts will have balances close enough to $100,000 that some of the rebalancing transfers are not necessary that time around, and overall transfer costs are lowered.

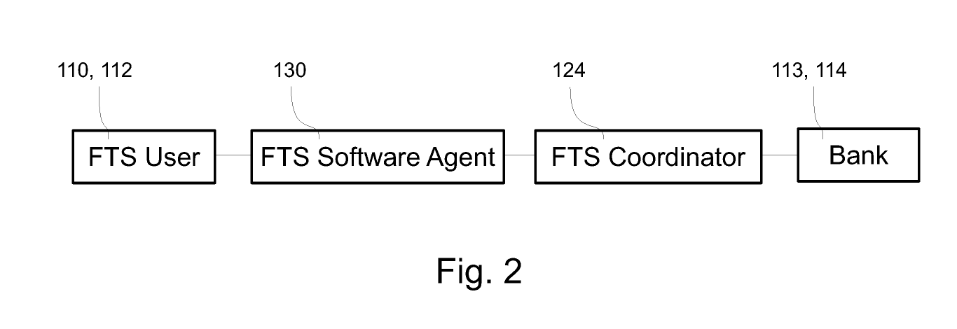

Referring to FIG. 2, in an example embodiment there are four types of entities in the FTS system: the FTS users 110, 112, the FTS software agents 130, the FTS Coordinator 124, and participating banks 113, 114. An FTS user is a human who uses the service to transfer money using an FTS client; An FTS software agent 130 is appropriate software or firmware configured to communicate with the FTS Coordinator 124 over a medium, such as the Internet, WIFI, cellular networks, etc. In an example embodiment, mobile device apps may function as FTS software agents 130. In another example embodiment, business accounting software may function as FTS software agents 130. In another example embodiment, a participating bank's web site may function as an FTS software agent 130. In another example, an entity such as a stock exchange may itself function as an FTS Coordinator on behalf of its own customers, in which case the FTS software agents 130 would be other internal software components of the entity, such as an order taking component. In general, any device that is capable of communicating with the FTS Coordinator 124 over a network may function as an FTS software agent 130. A software agent 130 may use a “front-end” application programming interface (API) 140 (a) and 140 (b) (see FIG. 1) which is accepted by the FTS. An API specifies how some software components should interact with each other, and specifies the communication protocol for exchanging messages related to the service. The front-end API may allow the software agent 130 and the FTS to communicate securely and reliably. In an example embodiment, the API requires that the Secure Sockets Layer (SSL) protocol be used to encrypt and authenticate the communication between the software agent 130 and the FTS. In an example embodiment, the front-end API uses the principles of Representational State Transfer (REST), which are well known to those skilled in the art.

In an example embodiment, in order for a person to be an FTS user, the person may be required to be associated with a bank account at a bank enabled to participate in FTS transfers. The user may be required to perform an authorization of their software agent 130 using credentials provided by their bank, such as by entering an access key or code. No relationship need ever exist between the user and the FTS.

In an example embodiment, FTS software agent 130 functions to communicate with the FTS Coordinator 124 using the API 140 (a) and 140 (b), and is configured with the access key corresponding to the appropriate bank account. The FTS software agents 130 communicate on behalf of the FTS users. The FTS users may be defined by the partner banks. The FTS may function only as an intermediary.

In an example embodiment, the FTS makes available to any qualified third-party software provider the protocol for the FTS Coordinator 124 Front-End API 140 (a) and 140 (b), allowing the software provider to develop an FTS software agent independently of the FTS and/or any bank, and to integrate that FTS software agent into their own software. Then the particular FTS software agent may be chosen according to the person's preferences. No business relationship need be established between the FTS and the maker of the software agent. In an example embodiment, an FTS software agent is integrated into a wide variety of software applications for which the function of transferring money is merely one aspect. Examples of such applications might include gambling applications, applications provided by a vendor to manage that vendor's services, applications that manage subscriptions requiring periodic payment, applications for business travelers that create and manage expense reports, any e-commerce website, any brokerage website, any electronic service enabling transfer of money, etc.

In an example use case, a party at a restaurant may split the bill utilizing the FTS and a cell phone app designed for that purpose. In such example, one person pays the bill and broadcasts the bill total and breakdown to the other people at the table via a medium such as WIFI, BLUETOOTH, NFC, etc. The recipients may then provide reimbursement via the FTS, and settle the matter using their preferred FTS software agent.

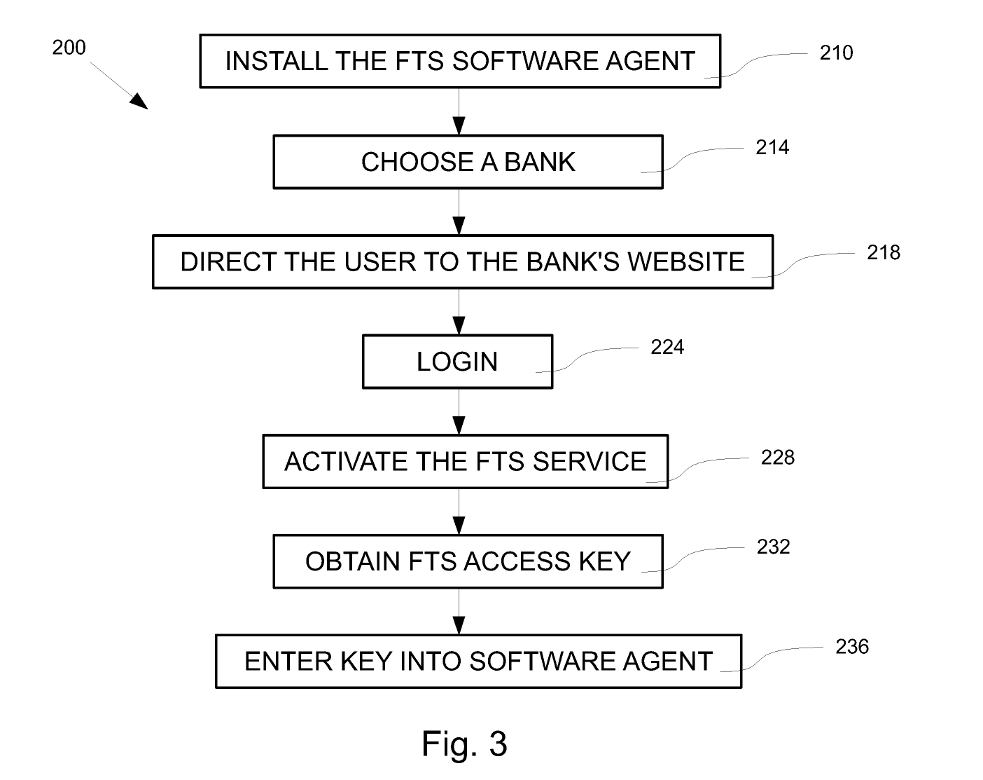

Referring to FIG. 3, an example user FTS setup 200 includes installing an FTS software agent (or downloading an app) in step 210, choosing a bank with which the FTS user has an established bank account from a list of partner banks in step 214. Selecting a bank then results in directing the user to the bank's web site in step 218. The user then performs a normal login to the bank's web site in step 224. The user then activates the FTS service (if required by the bank) in step 228, and then obtains an FTS key in step 232. The key is then entered into the software agent to configure it for the FTS in step 236. No additional sign-up or registration is required.

In an example embodiment, the user has no existing bank account when starting setup process 200. In this variation, in step 210 the user would choose any bank, and then in step 228 the user would then create a new account to be used with the FTS service at that bank.

In an example embodiment, an updated list of partner banks can be obtained by the software agent 130 over the Internet.

In an example embodiment, the FTS Coordinator 124 maintains a dedicated, secure computer connection with each participating bank using “back-end” API 140(e) and 140(f) which communicates with a corresponding API 140(c) and 140(d) at the partner banks. Messages are passed over this connection to effect transfers, and may perform other maintenance functions. Each message that initiates a withdrawal is authenticated using an access key, which is known to the sender's bank and to the sender's software agent 130, but may not necessarily be known to the FTS Coordinator 124. All such messages originate at the software agent 130, and are authenticated by the software agent 130 using the access key. The authentication may be performed using a secure hash algorithm (for example, SHA256 HMAC). Secure hash algorithms have the property that access to the output of the authentication process does not reveal the access key. The FTS Coordinator 124 may perform basic validation of the request before passing it on to the sender bank, but does not itself have the ability to decode the access key. Because the FTS Coordinator 124 never sees the access key, and is cryptographically prevented from decoding it, it is therefore impossible for the FTS Coordinator 124 to effect any transfer on its own.

Continuing the example, the bank may independently validate the request and verify proper authorization with the access key. The bank may thereby entirely control the risk of unauthorized transfers. In addition, banks may support or enforce other fraud prevention measures, such as regular password changes, restricting transfers to a predetermined destination list or “whitelist”, etc.

In an example embodiment, the bank issues multiple independent access keys for each account, where the different keys may only be used to pay certain recipients, be limited to certain transfer amounts and/or frequency, or other useful restrictions. The bank can enforce these restrictions at the time of an attempted transfer by accepting or refusing the transfer. These restrictions may be configured by the user via the bank's web site.

In an example use, other convenience functions may be performed using the FTS communication channel, such as real-time account balance queries. This would allow an FTS software agent 130 to show the customer's account balance before and after each transaction, and/or permit the software agent 130 to view real-time queries of recent account transactions.

In an example embodiment, a request for payment or funds transfer is required for an FTS funds transfer to occur. A request for funds transfer may include but is not restricted to such exemplary information (known as “metadata”) as: (a) the amount of funds to transfer, (b) the destination account for the transfer, (c) a description of the funds transfer, and (d) other optional arbitrary identifiers (such as invoice numbers and purchase order numbers). Information about who is expected to make the funds transfer may not be required.

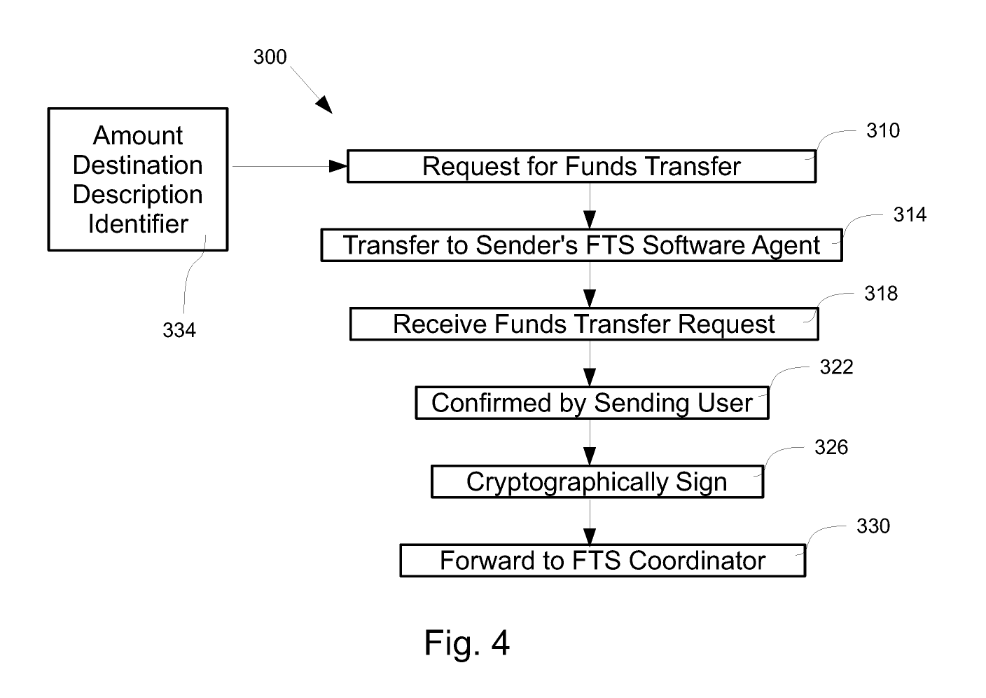

Referring to FIG. 4, an example for a funds transfer 300 includes generating a request for funds transfer in step 310 and transferring it to the sender's FTS software agent 130 in step 314. Once a request for funds transfer is received in step 318, it is confirmed by the user in step 322, cryptographically signed using their access key in step 326, and then forwarded to the FTS Coordinator 124 for processing in step 330. Metadata 334 may be provided with the request for transfer of funds.

In an example embodiment, the description of the transfer appears on both the sender's and the recipient's bank statements for verification. In addition, the information may be downloaded into third party accounting/administrative programs, such as QUICKBOOKS™, etc.

A visible and compact form of a request for funds transfer may be a funds transfer token, which represents a request for funds transfer. In an example embodiment, a token may be in the form of a URL (for example, https://FTS.com/t/A5k3Xu9FTSNQ48) and may be delivered in a number of ways, such as: automated means; manually; SMS; email; Bluetooth; near-field communications (NFC); etc.

In an example embodiment, a person may click on, or cut and paste these URLs into a web browser, which will lead the payer to a bank's website to complete the funds transfer. This serves as a manual way for a payer that doesn't have an FTS software agent to complete a funds transfer so that a payer who does not have an FTS software agent may use their bank's website as the FTS software agent.

The funds transfer token is a unique identifier, and the transfer information associated with the funds transfer token may not necessarily be embedded in the token. If not, an FTS software agent may use the FTS Coordinator 124 web API to access the token's associated metadata.

In an example embodiment, a software agent 130 may specify to the FTS Coordinator 124 when creating a request for funds transfer that only a specific other entity (e.g., the one expected to make the funds transfer) is allowed to decode the token, wherein the token has no meaning and cannot be deciphered by all other FTS software agents because the FTS Coordinator web API would prevent it.

Loading a funds transfer token into an FTS software agent may be an indication that the user wishes to view and potentially confirm a corresponding funds transfer. The software agent 130 then presents to the user the transfer information associated with the funds transfer request. If the user accepts the funds transfer request, the funds transfer is made. A funds transfer may fail for a number of reasons, such as if the recipient no longer wishes to accept the funds transfer (i.e., the request was canceled), there are insufficient funds, etc.

In an example embodiment, funds transfer tokens may be created and transferred at a point of sale, or between individuals ad hoc. They may be sent to payers wirelessly via SMS, email, Bluetooth, near-field communications (NFC), etc.

In an example embodiment, further additional information may be included in the funds transfer request. For example, a flag can be included that indicates that the recipient of the funds transfer requests to receive the sender's email address, or other information which may have to be confirmed with the funds transfer. Businesses may harvest customer information in this way.

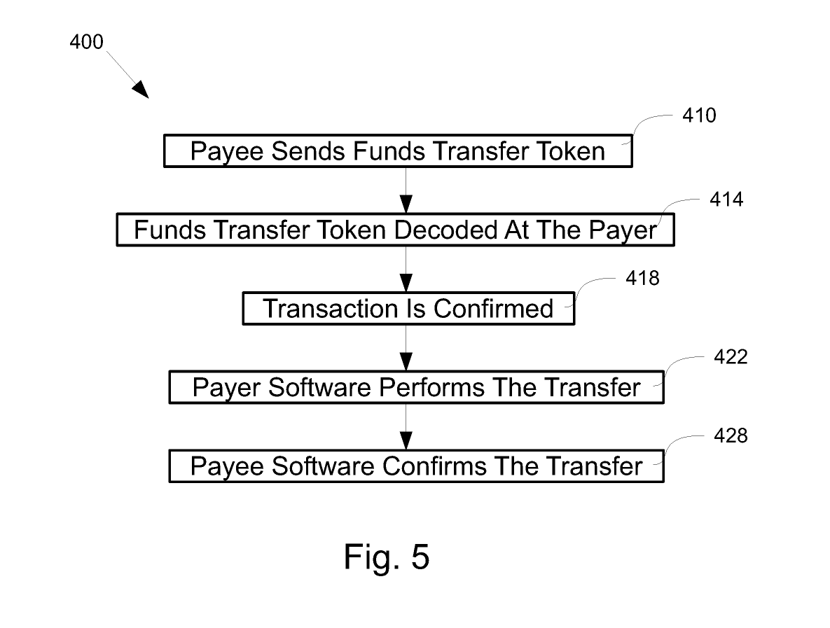

Referring to FIG. 5, an example business-to-business funds transfers system 400 may be entirely automatic wherein a payee sends a funds transfer token to a dedicated payer email address (e.g., the FTS@example.com) in a step 410. The funds transfer token would then be decoded at the payer in a step 414, the transaction is then confirmed via the information associated with the token in a step 418 (for example, a purchase order number), and the payer software, acting as an FTS software agent, uses the FTS Coordinator API to perform the transfer in step 422. In an example embodiment, the funds transfer token is presented to a human to confirm manually. The payee's software, also acting as an FTS software agent, uses the FTS Coordinator API to confirm the successful transfer in step 428.

In an example embodiment, if only one side has automated software, the other side may still participate. For example, a payee generates a funds transfer token manually using a web site, or a payer manually clicks on a funds transfer token URL to make a payment. In a further example, if a person does not participate in the FTS, he or she may (at a minimum) view a funds transfer request and initiate payment using traditional means.

The FTS Coordinator 124 may not maintain a direct relationship with the FTS customers. All relationship management may be handled by the partner banks, which may maintain control of their customers' use of the service, such as have veto power over any transaction, determine charges users pay for the service, provide users with multiple access keys, allow senders/receivers access, user monthly limits, etc. In an example, there is no actual per-transaction cost to the bank to implement the service such that the FTS service may be provided cheaply or freely as a competitive feature, similar to free checking. If a user loads multiple access keys, he or she may choose the appropriate access key for each funds transfer, and each may have a different set of authorized actions.

In an example embodiment, a bank may allow any of their customers, whether or not they have any knowledge of the FTS, to receive incoming transfers. Customers may be required to authorize funds transfers such as by an email with a confirmation link. To support unsolicited funds transfers, recipient banks may generate funds transfer tokens on behalf of the recipient. For example, an employer may ask an employee's bank to create a funds transfer request on behalf of the employee for direct payroll deposit. The employer would pay the employee of that request using the FTS service. This funds transfer may only require that the payer know only the recipient's bank and account number. Additional identifying information, such as an SSN, may be a requirement. Contractors and employees may be requested (or required) to generate funds transfer tokens in order to get paid; in addition, the funds transfer token may also be required to include specific other information such as an employee ID or job number that allows the accounting system to link the funds transfer to the correct account, etc.

In an example embodiment, businesses such as utilities, credit card companies, etc., that send regularly scheduled bills to consumers may include funds transfer tokens with their bills (or in emails).

What is described herein is a low-cost money transfer platform that enables individuals and businesses to make substantially instantaneous funds transfers directly from one financial institution account to another without needing an intermediary, thereby avoiding third party registration. The FTS is secure and may only require each account holder's bank (rather than each account holder individually) to have a relationship with the FTS. The platform of the invention allows banks to continue to own the customer relationship, and to control and manage transfers to provide useful features and to minimize risk. The platform of the invention allows arbitrary third-party software applications to easily participate in the service.

It should be understood that the programs, processes, methods, and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

Other modifications and implementations will occur to those skilled in the art without departing from the spirit and the scope of the invention as claimed. Accordingly, the above description is not intended to limit the invention except as indicated in the following claims.

What is claimed is:

1. A method for making low-cost instantaneous funds transfers from a bank account of a sender directly to a bank account of a recipient, the method comprising:
after receiving instructions to transfer funds from a bank account of the sender in a first bank to a bank account of the recipient in a second bank,
transmitting instructions to the first bank to transfer funds from the bank account of the sender in the first bank to a first funds transfer system account in the first bank;
transmitting instructions to the second bank to transfer funds from a second funds transfer system account in the second bank to the bank account of the recipient in the second bank;
transferring funds from the bank account of the sender in the first bank to a first funds transfer system account in the first bank; and
transferring funds from the second funds transfer system account in the second bank to the bank account of the recipient in the second bank.

2. The method of claim 1, wherein transmitting instructions to the first bank to transfer funds from the bank account of the sender in the first bank to a first funds transfer system account in the first bank is made to occur substantially simultaneously with transmitting instructions to the second bank to transfer funds from a second funds transfer system account in the second bank to the bank account of the recipient in the second bank.

3. The method of claim 1, wherein transferring funds from the bank account of the sender in the first bank to a first funds transfer system account in the first bank is made to occur substantially simultaneously with transferring funds from the second funds transfer system account in the second bank to the bank account of the recipient in the second bank.

4. The method of claim 1, wherein either:
both transferring funds from the bank account of the sender in the first bank to a first funds transfer system account in the first bank is made to occur, and
transferring funds from the second funds transfer system account in the second bank to the bank account of the recipient in the second bank is made to occur; OR
neither transferring funds from the bank account of the sender in the first bank to a first funds transfer system account in the first bank is made to occur,
nor is transferring funds from the second funds transfer system account in the second bank to the bank account of the recipient in the second bank made to occur.

5. The method of claim 1, further including:
before receiving instructions from a sender of funds to transfer funds from a bank account of the sender in a first bank to a bank account of the recipient in a second bank,
both sender and recipient irrevocably agree that the transaction is allowed; and
the transaction is confirmed to both sender and recipient.

6. The method of claim 1, further comprising:
before transferring funds from the second funds transfer system account in the second bank to the bank account of the recipient in the second bank, determining whether the second funds transfer system account has enough money to remain positive after transferring funds; and
if the second funds transfer system account does not have enough money to remain positive after transferring funds, borrowing funds from a funding source to at least cover the transferring of funds from the second funds transfer system account in the second bank to the bank account of the recipient in the second bank.

7. A system for making low-cost instantaneous funds transfers from a bank account of a sender in a first bank directly to a bank account of a recipient in a second bank, the system comprising:
a first funds transfer system (FTS) account in a first bank capable of participating in internal funds transfers with other accounts in the first bank;
a second funds transfer system (FTS) account in a second bank capable of participating in internal funds transfers with other accounts in the second bank;
a FTS software agent capable of communicating funds transfer instructions; and
a funds transfer system (FTS) coordinator having:
a rebalancing coordinator capable of determining amounts and times of funds transfers among a plurality of FTS accounts so as to minimize negative balances in the plurality of FTS accounts;
an interbank funds transfer network interface for communicating with an interbank funds transfer network capable of transferring funds among the plurality of FTS accounts in accordance with instructions from the rebalancing coordinator;
a front-end for receiving funds transfer instructions via an API from the FTS software agent; and
a back-end for:
sending funds transfer instructions via an API to an API of the first bank so as to cause a first transfer of funds from a bank account of the sender in the first bank to the first FTS account in the first bank,
sending funds transfer instructions via an API to an API of the second bank so as to cause a second transfer of funds from the second FTS account in the second bank to a bank account of the recipient in the second bank,
sending from the first bank to the FTS coordinator confirmation of the first transfer of funds, and
sending from the second bank to the FTS coordinator confirmation of the second transfer of funds.

8. The system of claim 7, wherein the FTS software agent capable of communicating funds transfer instructions to the FTS coordinator includes an interface to at least one of:
any gambling service, any e-commerce website, any brokerage website, any electronic service enabling transfer of money.

9. The system of claim 7, wherein the funds transfer instructions sent via an API from the FTS software agent to the FTS coordinator include metadata relating to the funds transfer.

10. The system of claim 7, wherein the FTS software agent is capable of receiving from the FTS Coordinator at least one of:
confirmation of the funds transfer; and
current balance information of the bank account of the sender.

11. The system of claim 7, further including a recipient FTS software agent, wherein the recipient FTS software agent is capable of receiving from the FTS Coordinator at least one of:
confirmation of the funds transfer; and
current balance information of the bank account of the recipient.
